(19) United States
(12) Patent Application Publication
(10) Pub. No.: US 2023/0419001 A1
(43) Pub. Date: Dec. 28, 2023

(54) THREE-DIMENSIONAL FLUID REVERSE MODELING METHOD BASED ON PHYSICAL PERCEPTION

(71) Applicant: BEIHANG UNIVERSITY, Beijing (CN)

(72) Inventors: Yang GAO, Beijing (CN); Xueguang XIE, Beijing (CN); Fei HOU, Beijing (CN); Aimin HAO, Beijing (CN); Qinping ZHAO, Beijing (CN)

(21) Appl. No.: 18/243,538

(22) Filed: Sep. 7, 2023

Related U.S. Application Data
(63) Continuation of application No. PCT/CN2021/099823, filed on Jun. 11, 2021.

(30) Foreign Application Priority Data
Mar. 10, 2021 (CN) 202110259844.8

(51) Int. Cl. G06F 30/27; G06N 3/0464; G06N 3/048

(52) U.S. Cl. CPC G06F 30/27; G06N 3/0464; G06N 3/048

(57) ABSTRACT

A three-dimensional fluid reverse modeling method based on physical perception. The method comprises: encoding a fluid surface height field sequence by a surface velocity field convolutional neural network to obtain a surface velocity field at a time t; inputting the surface velocity field into a pre-trained three-dimensional convolutional neural network to obtain a three-dimensional flow field, wherein the three-dimensional flow field includes a velocity field and a pressure field; inputting the surface velocity field into a pre-trained regression network to obtain fluid parameters; and inputting the three-dimensional flow field and the fluid parameters into a physics-based fluid simulator to obtain a time series of the three-dimensional flow field. The requirements for real fluid reproduction and physics-based fluid reediting are met.

### CROSS-REFERENCE TO RELATED APPLICATIONS

The present application is a bypass continuation application of PCT application number PCT/CN2021/099823. This application claims priorities from PCT application number PCT/CN2021/099823, filed Jun. 11, 2021, and from Chinese application number 2021102598448, filed Mar. 10, 2021, the disclosure of which are hereby incorporated by reference herein in its entirety.

### TECHNICAL FIELD

The embodiments of the present disclosure relate to the field of fluid reverse modeling technology, and in particular to a three-dimensional fluid reverse modeling method based on physical perception.

### BACKGROUND

With the development of computer technology, the reproduction of fluid in computers has become imperative in such fields as gaming/film production and virtual reality. Therefore, in the past two decades, it has received extensive attention in the field of computer graphics. Modern physics-based fluid simulators can generate vivid fluid scenes based on given initial states and physical attributes. However, initial states are often over simplified, making it difficult to achieve specific results. Another solution for fluid reproduction is the inverse problem of the simulation process—capturing dynamic fluid flow fields in the real world and then reproducing the fluid in a virtual environment. However, for decades, it has remained a challenging problem, because fluids do not have a stationary shape and there are too many variables to capture in the real world.

In the field of engineering, people use complex devices and techniques to capture three-dimensional fields, such as synchronous cameras, staining solutions, color coding or structured lighting, and laser equipment. But in the field of graphics, more convenient collection devices are often used to obtain fluid videos or images, and then volume or surface geometric reconstruction is carried out based on graphics knowledge. This method often fails to reconstruct the internal flow field, or the reconstructed internal flow field is not accurate enough to be applied to physically correct re-simulations. Therefore, modeling three-dimensional flow fields from simple and uncalibrated fluid surface motion images is a challenging task.

On the other hand, there are currently some issues with the methods of re-simulation from captured fluids. Gregson et al. conducted fluid re-simulation by increasing the resolution of a captured flow field. Currently, it is very difficult to re-edit more complex scenes that guarantee physical correctness, such as adding fluid solid coupling and multiphase flow, due to the lack of physical attributes of the fluid. Among them, the determination of the physical attributes of the fluid becomes a bottleneck. One possible approach is to use the material parameters listed in the book or measured in the real world. However, generally speaking, the parameter values of most fluid materials are not readily available, and measuring instruments cannot be widely used. Many methods manually adjust parameters through trial-and-error procedures, i.e., combining forward physical simulation and reverse parameter optimization for iteration, which is very time-consuming and in some cases exceeds the practical application range.

With the development of machine learning and other technologies, data drive has gradually become a popular method in computer graphics. The starting point of this technology is to learn new information from data to help people further understand the real world based on theoretical models and more accurately restore it. For the field of fluid, the idea of data drive is even more significant. Due to certain complex distribution rules in the fluid flow field, it is difficult to express them through equations. Therefore, using data-drive and machine learning to learn features in the fluid and generate fluid effects is one of the important and feasible methods at present.

In order to solve the above problems, the present disclosure proposes a fluid reverse modeling technique from surface motion to spatiotemporal flow field based on physical perception. It combines deep learning with traditional physical simulation methods to reconstruct three-dimensional flow fields from measurable fluid surface motions, thereby replacing the traditional work of collecting fluids through complex devices. First, by encoding and decoding the spatiotemporal features of the surface geometric time series, a two-step convolutional neural network structure is used to implement reverse modeling of the fluid flow field at a certain time, including surface velocity field extraction and three-dimensional flow field reconstruction, respectively. Meanwhile, the data-driven method uses a regression network to accurately estimate the physical attributes of the fluid. Then, the reconstructed flow field and estimated parameters are input as initial states into a physical simulator to implement explicit temporal evolution of the flow field, thereby obtaining a fluid scene that is visually consistent with the input fluid surface motion, and at the same time, implementing fluid scene re-editing based on estimated parameters.

### SUMMARY

The content of the present disclosure is to introduce concepts in a brief form, which will be described in detail in the specific implementation section below. The content of the present disclosure is not intended to identify key or necessary features of the claimed technical solution, nor is it intended to limit the scope of the claimed technical solution.

Some embodiments of the present disclosure propose a three-dimensional fluid reverse modeling method, apparatus, electronic device, and computer-readable medium based on physical perception to solve one or more of the technical problems mentioned in the background art section above.

In the first aspect, some embodiments of the present disclosure provide a three-dimensional fluid reverse modeling method based on physical perception, the method comprising: encoding a fluid surface height field sequence by a surface velocity field convolutional neural network to obtain a surface velocity field at a time t; inputting the surface velocity field into a pre-trained three-dimensional convolutional neural network to obtain a three-dimensional flow field, wherein the three-dimensional flow field includes a velocity field and a pressure field; inputting the surface velocity field into a pre-trained regression network to obtain fluid parameters; and inputting the three-dimensional flow field and the fluid parameters into a physics-based fluid simulator to obtain a time series of the three-dimensional flow field.

The above embodiments of the present disclosure have the following beneficial effects: firstly, encoding a fluid surface height field sequence by a surface velocity field convolutional neural network to obtain a surface velocity field at a time t, then inputting the surface velocity field into a pre-trained three-dimensional convolutional neural network to obtain a three-dimensional flow field, meanwhile, inputting the surface velocity field into a pre-trained regression network to obtain fluid parameters, and in the end, inputting the three-dimensional flow field and the fluid parameters into a physics-based fluid simulator to obtain a time series of the three-dimensional flow field, thereby overcoming the problem that the existing fluid capture methods require overly complex equipment and are limited by scenes, providing a data-driven fluid reverse modeling technique from surface motion to spatiotemporal flow field, using a designed deep learning network to learn the flow field's distribution patterns and fluid properties from a large number of datasets, making up for the lack of internal flow field data and fluid properties, and at the same time, conducting time deduction based on physical simulators, and meeting the requirements for real fluid reproduction and physics-based fluid re-editing.

The principles of the present disclosure are: firstly, the present disclosure utilizes a data-driven method, i.e., designs a two-stage convolutional neural network to learn the distribution patterns of the flow field in the dataset, so can perform reverse modeling on the input surface geometric time series, infer three-dimensional flow field data, and further can solve the problem of insufficient information provided by fluid surface data in a single scene. Besides, in the comprehensive loss function applied in the network training process, the flow field is constrained based on pixel points, the flow field spatial continuity is constrained based on blocks, the flow field temporal dimension continuity is constrained based on continuous frames, and the physical attributes are constrained based on parameter estimation networks, thus ensuring the accuracy of flow field generation. Secondly, the parameter estimation step also adopts a data-driven approach, using a regression network to learn rules from a large amount of data, enabling the network to perceive hidden physical factors of the fluid, thereby quickly and accurately estimating parameters. Thirdly, a traditional physical simulator is employed, which is able to utilize the reconstructed three-dimensional flow field and estimated parameters to implement explicit temporal dimension deduction of the flow field. At the same time, due to the explicit presentation of physical attributes, the present disclosure is able to re-edit the reproduced scene while ensuring physical correctness.

The advantages of the present disclosure compared to the prior art are:

Firstly, compared to existing methods for collecting flow fields based on optical characteristics, the approach proposed by the present disclosure of reverse modeling three-dimensional fluid from surface motion avoids complex flow field acquisition equipment and reduces experimental difficulty. And once the network is trained, the application speed is fast, the accuracy is high, and the experimental efficiency is improved.

Secondly, compared to existing data-driven fluid re-simulation methods, the present disclosure, having estimated the fluid's attribute parameters, can implement scene re-editing under physical guidance, being more widely applicable.

Thirdly, compared with existing fluid parameter estimation methods, the present disclosure omits the complex iterative process of forward simulation and reverse optimization, being able to quickly and accurately identify the physical parameters of the fluid.

### BRIEF DESCRIPTION OF THE DRAWINGS

The above and other features, advantages, and aspects of the embodiments of the present disclosure will become more apparent in conjunction with the accompanying drawings and with reference to the following specific implementations. Throughout the drawings, the same or similar reference signs indicate the same or similar elements. It should be understood that the drawings are schematic, and the components and elements are not necessarily drawn to scale.

FIG. 1 is a flowchart of some embodiments of a three-dimensional fluid reverse modeling method based on physical perception according to some embodiments of the present disclosure;

FIG. 2 is a schematic diagram of a regression network structure;

FIGS. 3A-3B are schematic diagrams of a surface velocity field convolutional neural network and its affiliated network structure;

FIG. 4 is a schematic diagram of the training process of the surface velocity field convolutional neural network;

FIG. 5 is a schematic diagram of the three-dimensional flow field reconstructed network architecture;

FIG. 6 is a comparison of re-simulation results with real scenes;

FIG. 7 is the re-edited fluid solid coupling result;

FIG. 8 is the re-edited multiphase flow result;

FIG. 9 is the re-edited viscosity adjustment result.

### DETAILED DESCRIPTION OF THE DISCLOSURE

Hereinafter, the embodiments of the present disclosure will be described in more detail with reference to the accompanying drawings. Although certain embodiments of the present disclosure are shown in the drawings, it should be understood that the present disclosure may be implemented in various forms, and shall not be construed as being limited to the embodiments set forth herein. On the contrary, these embodiments are provided for a more thorough and complete understanding of the present disclosure. It should be understood that the drawings and embodiments of the present disclosure are used only for illustrative purposes, not to limit the protection scope of the present disclosure.

Besides, it should be noted that, for ease of description, only the portions related to the relevant disclosure are shown in the drawings. In the case of no conflict, the embodiments in the present disclosure and the features in the embodiments may be combined with each other.

It should be noted that concepts such as “first” and “second” mentioned in the present disclosure are only used to distinguish different devices, modules or units, and are not used to limit the order of functions performed by these devices, modules or units or interdependence thereof.

It should be noted that such adjuncts as “one” and “more” mentioned in the present disclosure are illustrative, not restrictive, and those skilled in the art should understand that, unless the context clearly indicates otherwise, they should be understood as “one or more”.

The names of messages or information exchanged between multiple devices in the embodiments of the present disclosure are only for illustrative purposes, and are not intended to limit the scope of these messages or information.

The present disclosure will be described in detail below with reference to the accompanying drawings and in conjunction with embodiments.

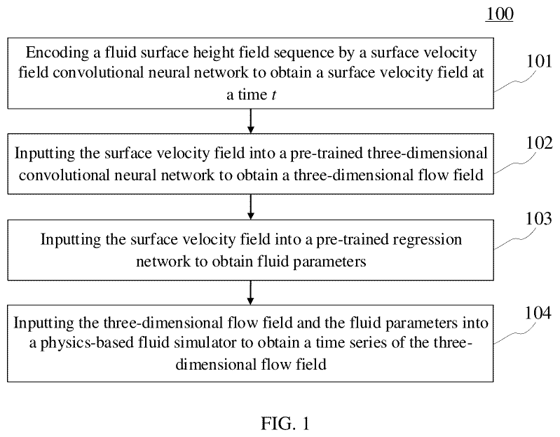

FIG. 1 is a flowchart of some embodiments of a three-dimensional fluid reverse modeling method based on physical perception according to some embodiments of the present disclosure. This method can be executed by the computing device 100 in FIG. 1. This three-dimensional fluid reverse modeling method based on physical perception comprises the following steps:

Step 101, encoding a fluid surface height field sequence by a surface velocity field convolutional neural network to obtain a surface velocity field at a time t.

In some embodiments, the executing body of the three-dimensional fluid reverse modeling method based on physical perception (such as the computing device 100 shown in FIG. 1) can use a trained convolutional neural network f_{conv1} to encode the time series {h\hat{ }(t−2), h\hat{ }(t−1), h\hat{ }t, h\hat{ }(t+1), h\hat{ }(t+2)} containing 5 frames of surface height field, and obtain the surface velocity field at a time t.

Step 102, inputting the surface velocity field into a pre-trained three-dimensional convolutional neural network to obtain a three-dimensional flow field.

In some embodiments, the above executing body can infer the three-dimensional flow field of the fluid using a three-dimensional convolutional neural network f_{conv2} based on the surface velocity field obtained in step (101), wherein the three-dimensional flow field includes a velocity field and a pressure field.

Step 103, inputting the surface velocity field into a pre-trained regression network to obtain fluid parameters.

In some embodiments, the above executing body can use a trained regression network f_{conv3} to estimate fluid parameters and identify fluid parameters that affect fluid properties and behavior. Inferring the hidden physical quantities in fluid motion is an important aspect of physical perception.

Step 104, inputting the three-dimensional flow field and the fluid parameters into a physics-based fluid simulator to obtain a time series of the three-dimensional flow field.

In some embodiments, the above executing body can input the reconstructed flow field (three-dimensional flow field) and the estimated fluid parameters into a traditional physics-based fluid simulator to obtain a time series of the three-dimensional flow field, thus completing the task of reproducing the observed fluid scene images in a virtual environment. At the same time, by explicitly adjusting the parameters or the initial flow field data, fluid scene re-editing under physical guidance is achieved.

Optionally, the surface velocity field convolutional neural network mentioned above includes a convolutional module group and a dot product mask operation module. The convolutional module group includes eight convolutional modules, and the first seven convolutional modules in the convolutional module group are of a 2DConv-BatchNorm-ReLU structure, while the last convolutional module in the convolutional module group adopts a 2DConv-tan h structure; and

The above encoding a fluid surface height field sequence by a surface velocity field convolutional neural network to obtain a surface velocity field at a time t includes:

Inputting the fluid surface height field sequence into the surface velocity field convolutional neural network to obtain a surface velocity field at a time t.

Optionally, the surface velocity field convolution neural network is a network obtained by using a comprehensive loss function in the training process, wherein the comprehensive loss function is generated by the following steps:

The pixel level loss function based on L1 norm, spatial continuity loss function based on discriminator, temporal continuity loss function based on discriminator, and loss function based on the constraint physical attributes of the regression network are used to generate the above comprehensive loss function:

L(f_{conv1},Dₛ,Dₜ)=δ×Lₚᵢₓₑₗ+α×L_{D}_{ₛ}+β×L_{D}_{ₜ}+γ×L_{ν}.

Wherein, L(f_{conv1}, Dₛ, Dₜ) represents the comprehensive loss function. δ represents the weight value of the pixel level loss function based on the L1 norm. Lₚᵢₓₑₗ represents the pixel level loss function based on L1 norm. α represents the weight value of spatial continuity loss function based on discriminator. L_{D}_{ₛ} represents the spatial continuity loss function based on discriminator. β represents the weight value of temporal continuity loss function based on discriminator. L_{Dt} represents the temporal continuity loss function based on discriminator. γ represents the weight value of the loss function based on the constraint physical attributes of the regression network. L_{ν} represent the mean square error loss function based on the constrained physical attributes of the regression network.

Optionally, the three-dimensional convolutional neural network includes a three-dimensional deconvolution module group, which includes five three-dimensional deconvolution modules. The three-dimensional convolutional neural network supports dot product mask operation, and the three-dimensional deconvolution modules in the three-dimensional deconvolution module group include a Padding layer, a 3DDeConv layer, a Norm layer, and a ReLU layer. The three-dimensional convolutional neural network is a network obtained by using a flow field loss function in the training process; and

The flow field loss function is generated by the following formula:

L(f_{conv2})=ε×E_{u,û}[∥u−û∥₁]+θ×E_{p,\hat{p}}[∥p−\hat{p}∥₁].

Wherein, L(f_{conv2}) represents the flow field loss function. ε represents the weight value of the velocity field generated by the three-dimensional convolutional neural network during the training process. u represents the velocity field generated by the three-dimensional convolutional neural network during the training process. û represents the sample true velocity field received by the three-dimensional convolutional neural network during the training process. ∥ ∥₁ represents the L1 norm. θ represents the weight value of the pressure field generated by the three-dimensional convolutional neural network during the training process. p represents the pressure field generated by the three-dimensional convolutional neural network during the training process. \hat{p} represents the sample true pressure field received by the three-dimensional convolutional neural network during the training process. E represents the calculation of mean square error.

Optionally, the regression network includes: one 2DConv-LeakyReLU module, two 2DConv-BatchNorm-LeakyReLU modules and one 2DConv module. The regression network is a network obtained by using the mean square error loss function in the training process; and

The above mean square error loss function is generated by the following formula:

L_{ν}=E_{ν,\hat{ν}}[(ν−\hat{ν})²].

Wherein, L_{ν} represents the mean square error loss function. ν represents the fluid parameter generated by the regression network during the training process. \hat{ν} represents the sample true fluid parameter received by the regression network during the training process. E represents the calculation of mean square error.

In practice, the present disclosure provides a fluid reverse modeling technique from surface motion to spatiotemporal flow field based on physical perception. To be specific, it is reconstructing from the time series of fluid surface motion a three-dimensional flow field with consistent motion and its time evolution model, first using a deep learning network for three-dimensional flow field reconstruction and attribute parameter estimation, then taking this as the initial state, using a physical simulator to obtain a time series. The fluid parameter involved here is the viscosity of the fluid. Considering that directly learning the three-dimensional flow field from the time series of the surface height field is relatively difficult and hard to explain, the present disclosure completes it in steps, i.e., using a sub-network responsible for extracting a surface velocity field from the surface height sequence, similar to obtaining derivatives, then using a second sub-network to reconstruct an internal velocity field and a pressure field from the surface velocity field, which is a generative model of the field with specific distribution characteristics. The main steps of the overall algorithm are as follows:
Input: Height field time series {h^{t-2}, h^{t-1}, h^{t}, h^{t-1}, h^{t+2}}, surface flow field classification label lₛ, and three-dimensional flow field classification label l;
Output: Three-dimensional flow field with multiple consecutive frames, including a velocity field u and a pressure field p;
1) Surface velocity field at time t uₛ^{t}=f_{conv1}(h^{t-2}, h^{t-1}, h^{t}, h^{t+1}, h^{t+2}, lₛ);
2) Three-dimensional velocity field and pressure field at time t (u^{t}, p^{t})=f_{conv2}(uₛ^{t}, h^{t}, l);
3) Fluid property viscosity coefficient ν=f_{conv3}(uₛ^{t}, h^{t});
4) Set the re-simulation initial state (u⁰, p⁰, l, ν)=(u^{t}, p^{t}, l, ν);
5) Iterative loop simulation program t=0→n, (u^{t+1}, p^{t+1})=simutator(u^{t}, p^{t}, l, ν);

6) Return to {u⁰, u¹, . . . , uⁿ}, {p⁰, p¹, . . . , pⁿ}.

Wherein, there are three deep learning networks and one physical simulator, the physical simulator is a traditional incompressible viscous fluid simulator based on Navier-Stokes equations. Below is a detailed introduction to the structure and training process of several networks:

1. Regression Network

A network f_{conv3} is used to estimate fluid parameters. Firstly, the real surface velocity field data in the training set is used for training; then, during the use, parameter estimation is performed on the surface velocity field generated by the network f_{conv1} Meanwhile, the parameter estimation network f_{conv3} is also applied in the training process of the network f_{conv1} to constrain its generation of surface velocity fields with specific physical attributes. Therefore, here we first introduce f_{conv3}.

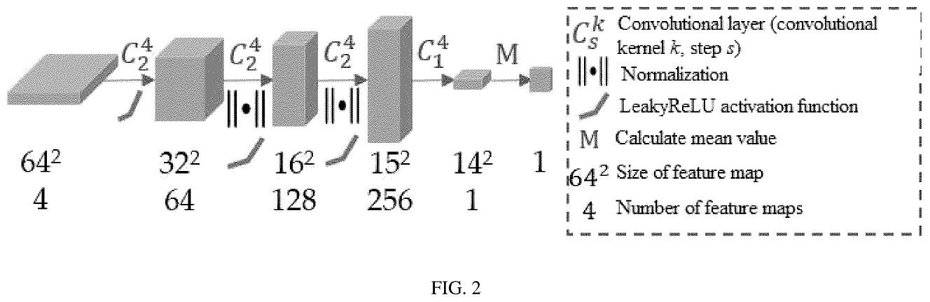

The structure of the regression network is shown in FIG. 2, wherein the small rectangular blocks represent the feature maps and their sizes are marked below each block. The input is a combination of the surface height field and the velocity field, with a size of 64×64×4. The output is an estimated parameter. The network includes one 2DConv-LeakyReLU module, two 2DConv-BatchNorm-LeakyReLU modules, and one 2DConv module. In the end, take the average of the acquired 14×14 data to obtain an estimated parameter. This structure ensures nonlinear fitting and accelerates the convergence speed of the network. Note that the present disclosure uses the LeakyReLU activation function with a slope of 0.2, instead of ReLU, when dealing with parameter regression problems. Meanwhile, this structure averages the generated 14×14 feature maps to obtain the final parameters, rather than using fully connected or convolutional layers, which plays the role of integrating the parameter estimation results of each small block in the flow field and is more suitable for high detailed surface velocity fields. In the network f_{conv3} training phase, use the mean square error loss function Lν to force the estimated parameter ν to be consistent with the actual parameter \hat{ν}, and specifically defined as:

L_{ν}=E_{ν,\hat{ν}}[(ν−\hat{ν}))²].

Wherein, L_{ν} represents the mean square error loss function. ν represents the fluid parameter generated by the regression network during the training process. \hat{ν} represents the sample fluid parameter received by the regression network during the training process. E represents the calculation of mean square error.

2. Surface Velocity Field Convolutional Neural Network

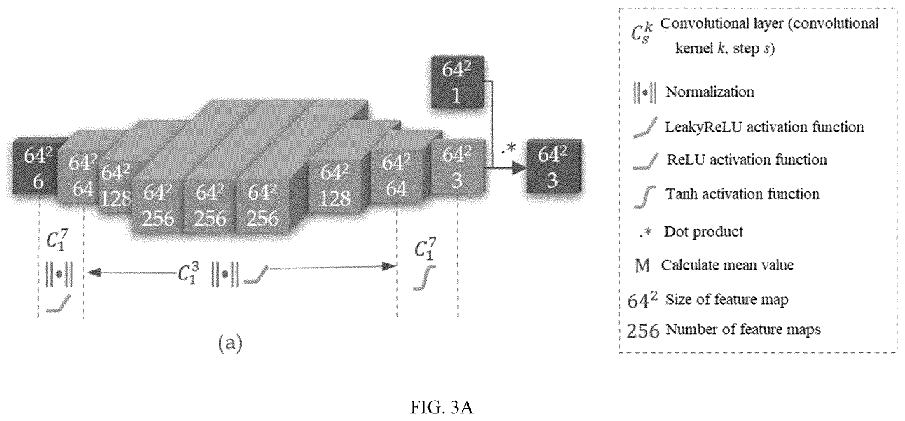

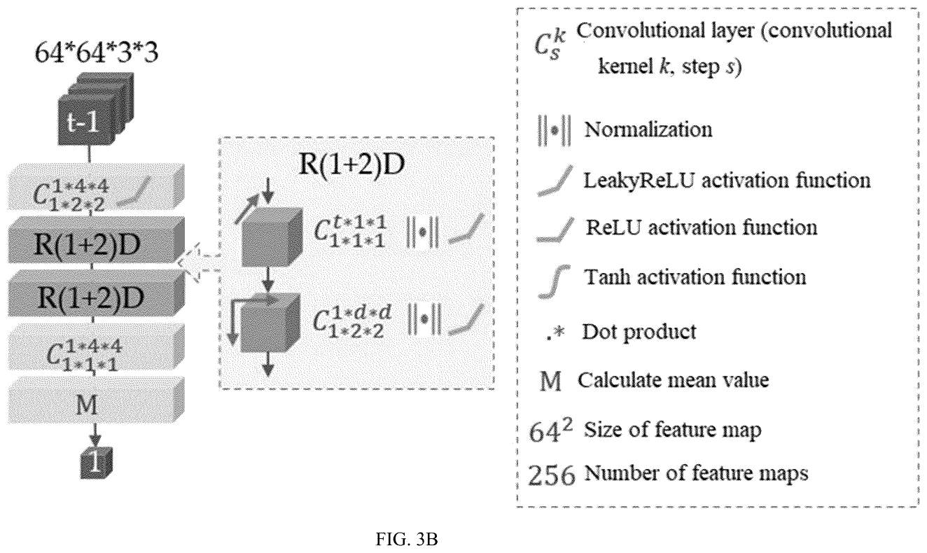

The convolutional neural network f_{conv1} structure for surface velocity field extraction is shown in FIG. 3A. Its first input is a combination of a 5-frame surface height field and a label map, with a size of 64×64×6. The other input is a mask, with a size of 64×64×1. The output is a surface velocity field of 64×64×3. The front of the network consists of 8 convolutional modules. Except for the last layer, which uses a 2DConv-tanh structure, each other module uses a 2DConv-BatchNorm-ReLU structure. Then, a dot product mask is used to extract fluid regions of interest and filter out obstacles and boundary regions. This operation can improve the fitting ability and convergence speed of the model. From the perspective of images, the present disclosure uses a pixel level loss function based on L1 norm to constrain the generated data of all pixel points to be close to the true value. From the perspective of flow fields, the velocity field should satisfy the following properties: 1) Spatial continuity caused by viscosity diffusion; 2) Temporal continuity caused by velocity convection; 3) Velocity distribution related to fluid properties. Therefore, the present disclosure additionally designs a spatial continuity loss function L(Ds) based on discriminator Ds, a temporal continuity loss function L(Dt) based on discriminator Dt, and a loss function Lv based on the constraint physical attributes of the trained parameter estimation network f_{conv3}. The comprehensive loss function is as follows:

L(f_{conv1},Dₛ,Dₜ)=δ×Lₚᵢₓₑₗ+α×L_{D}_{ₛ}+β×L_{D}_{ₜ}+γ×L_{ν}.

Wherein, L(f_{conv1}, Dₛ, Dₜ) represents the comprehensive loss function. δ represents the weight value of the pixel level loss function based on the L1 norm. Lₚᵢₓₑₗ represents the pixel level loss function based on L1 norm. α represents the weight value of the spatial continuity loss function based on discriminator. L_{D}_{ₛ} represents the spatial continuity loss function based on discriminator, β represents the weight value of the temporal continuity loss function based on discriminator. L_{D}_{ₜ} represents the temporal continuity loss function based on discriminator. γ represents the weight value of the loss function based on the constraint physical attributes of the regression network. L_{ν} represent the loss function based on the constraint physical attributes of the regression network. During the experiment, the four weight values are set to 120, 1, 1, and 50 respectively, which are determined based on the experimental results of several different weights.

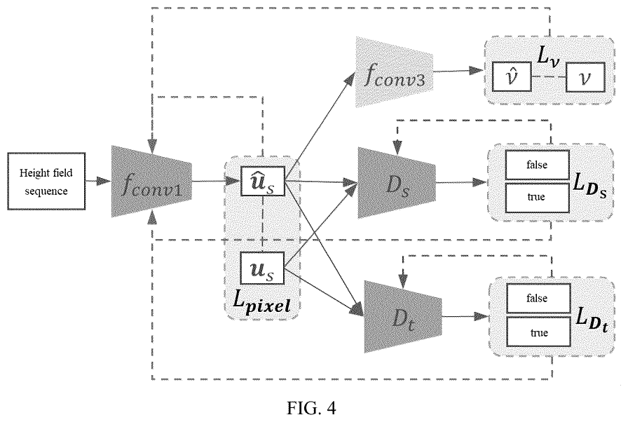

During training, the discriminator Ds and the discriminator Dt are trained against the network f_{conv1}. The trained parameter estimation network f_{conv3} as a function measures the physical attributes of the generated data, with fixed network parameters and not updated when training f_{conv1}. Specifics are shown in FIG. 4.

Spatial continuity: The loss function Lₚᵢₓₑₗ measures the difference between the generated surface velocity field and the true value at the pixel level, while L(Ds) generates a discriminator Ds to measure the difference at the block level. The combination of the two ensures that the generator can learn to generate more realistic spatial details. Wherein, the formula for Lₚᵢₓₑₗ is:

Lₚᵢₓₑₗ=Eᵤ_{ₛ}_{,û}ₛ[∥uₛ−ûₛ∥₁].

The discriminator Ds distinguishes between true and false based on the flow field of small blocks, rather than the entire flow field. Its structure is the same as f_{conv3}, but the input and output are different. In this paper, a LSGANs architecture is adopted, using the least square loss function to judge the results, replacing the traditional cross entropy loss function applied in GAN. The discriminator Ds and the generator f_{conv1} are optimized alternately. The discriminator wants to distinguish real data from the data generated by f_{conv1}, while the generator wants to generate fake data to deceive the discriminator. Therefore, the loss function of the generator is:

L_{D}_{_{S}}=E_{û}ₛ[(Dₛ(ûₛ)−1)²].

While the loss function of the discriminator is:

$${L}_{D} = \frac{1}{2} {E}_{{u}_{s}} [ {( {D}_{s} ( {u}_{s} ) - 1 )}^{2} ] + \frac{1}{2} {E}_{{\hat{u}}_{s}} [ {( {D}_{s} ( {\hat{u}}_{s} ) )}^{2} .$$

Temporal continuity: Namely, the network f_{conv1} receives multiple frames of surface height maps, but the generated surface velocity field is of a single moment. Therefore, Lₚᵢₓₑₗ and L(Ds) also act on a single frame result. Therefore, there are challenges in terms of temporal continuity in the result. The present disclosure uses a discriminator Dt to make the continuous frames of the generated surface velocity field as continuous as possible. The network structure of Dt is shown in FIG. 3B. The present disclosure does not use a three-dimensional convolutional network, but instead applies the module of R(2+1)D in Dt, i.e., uses 2D convolution to extract spatial and temporal features respectively. This structure is more effective in learning spatiotemporal data.

Specifically, Dt takes three consecutive results as input. The true value of the continuous surface velocity field is: {uₛ^{t-1}, uₛ^{t}, uₛ^{t+1}}, the generated data comes from the corresponding result ûₛ^{t-1}, ûₛ^{t}, ûₛ^{t+1} that calls up the generator f_{conv1} three times. The corresponding loss function is:

L_{D}_{_{S}}=E_{û}ₛ_{^{t−1}}_{,û}_{ₛ}_{^{t+1}}[(Dₛ(ûₛ^{t-1},ûₛ^{t},ûₛ^{t+1})−1)²].

In order to make the generated surface velocity field physically correct, it is necessary to ensure that the fluid has correct physical parameters. Therefore, the present disclosure designs a loss function Lv of physical perception to evaluate its physical parameters, and uses the trained parameter estimation network f_{conv3} as a loss function. Please note that unlike the discriminator mentioned above, this network maintains fixed parameters during the f_{conv1} training process and no longer undergoes network optimization. The specific formula is as follows:

L_{ν}=E_{ν,û}ₛ[ν−f_{conv3}(ûₛ))².

3. Three-Dimensional Flow Field Reconstructed Network

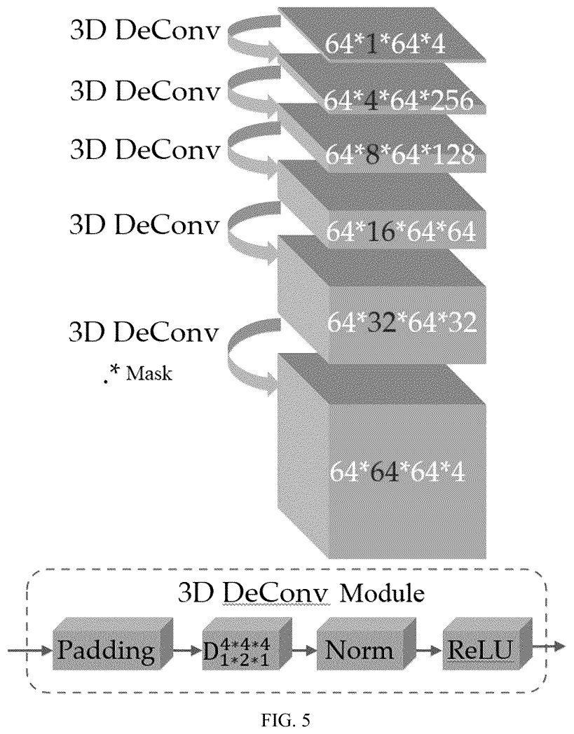

The network f_{conv2} infers internal information from the surface along the direction of gravity, and a three-dimensional deconvolution layer is applied to fit this function. FIG. 5 shows the specific structure of the three-dimensional flow field reconstructed network, which includes five three-dimensional deconvolution modules, each of which is composed of Padding, 3DDeConv, Norm, and ReLU layers. In order to accurately handle obstacles and boundaries in the scene, the present disclosure adds an additional dot product mask operation, using three-dimensional flow field labels as masks and setting the velocity and pressure to 0 in non-fluid regions, thereby reducing the difficulty of network fitting. The loss function of the network training process calculates the error of the velocity field and the pressure field respectively, and obtains the final flow field loss function through the weighted summation. The specific formula is as follows:

L(f_{conv2})=ε×E_{u,û}[∥u−û∥₁]+θ×E_{p,\hat{p}}[∥p−\hat{p}∥₁].

Wherein, L(f_{conv2}) represents the flow field loss function. ε represents the weight value of the velocity field generated by the three-dimensional convolutional neural network during the training process. u represents the velocity field generated by the three-dimensional convolutional neural network during the training process. û represents the sample velocity field received by the three-dimensional convolutional neural network during the training process. ∥ ∥₁ represents the L1 norm. θ represents the pressure field generated by the three-dimensional convolutional neural network during the training process. p represents the pressure field generated by the three-dimensional convolutional neural network during the training process. \hat{p} represents the sample pressure field received by the three-dimensional convolutional neural network during the training process. During execution, ε and θ are set to 10 and 1, respectively.

Due to the considerable difficulty in capturing the flow field, the present disclosure utilizes existing fluid simulators to generate the required data. The dataset includes surface height map time series, corresponding surface velocity fields, three-dimensional flow fields, viscosity parameters, and labels for tagging fluid, air, obstacle and other data. Scenes include scenes with square or circular boundaries, as well as scenes with or without obstacles. One assumption of the scenes is that the shape of obstacles and boundaries along the direction of gravity is constant.

The resolution of the data is 64\hat{ }3. In order to ensure sufficient variance in physical motion and dynamics, the present disclosure uses a random simulation device. The dataset contains 165 scenes with different initial conditions. Before all else, the first n frames are discarded because these data often contain visible splashes and the like, and the surface is usually not continuous, which is beyond the scope of the present disclosure's research. Then, the next 60 frames as saved a dataset. In order to test the generalization ability of the model towards the new scenarios that do not appear in the training set, the present disclosure randomly selects 6 complete scenes as a test set. At the same time, in order to test the model's generalization ability towards different cycles of the same scene, 11 frames are randomly cut from each remaining scene for testing. In order to monitor the overfitting of the model to determine the frequency of training, the remaining segments are randomly divided into a training set and a verification set, with a ratio of 9:1. Then normalize the training set, test set, and validation set all within the [−1,1] interval. Considering the correlation between the three components of velocity, the present disclosure normalizes them as a whole, rather than processing the three channels separately.

The present disclosure divides the training process into three stages. The parameter estimation network f_{conv3} is trained 1000 times; The network f_{conv1} is trained 1000 times; The f_{conv2} trained 100 times. The ADAM optimizer and exponential learning rate decay method are used to update the weights and learning rates of the neural network, respectively.

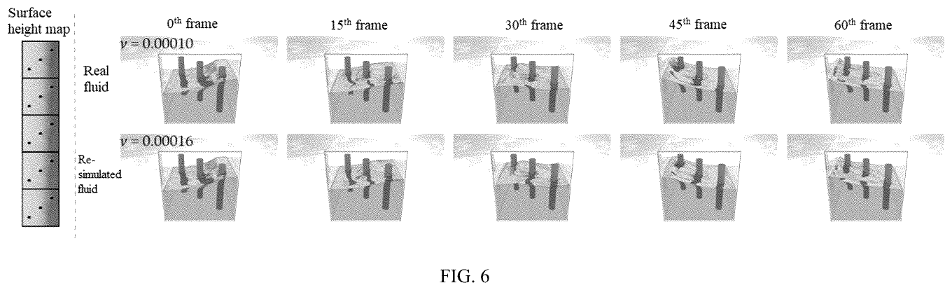

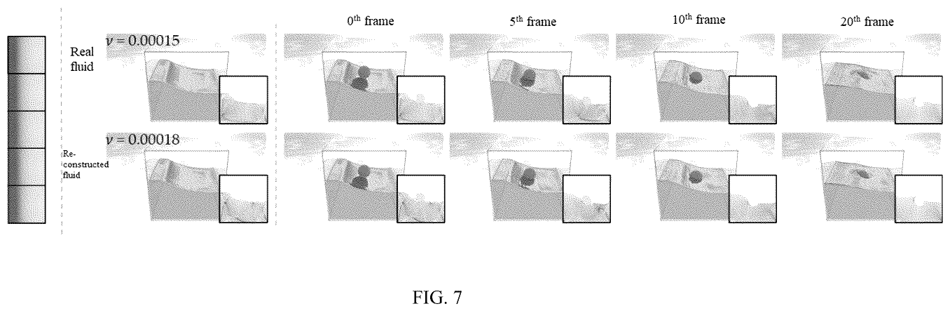

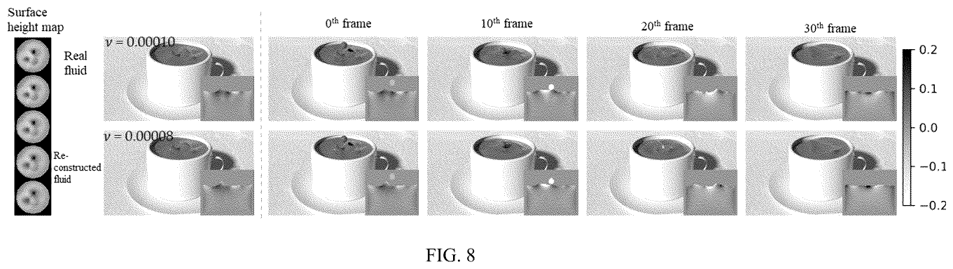

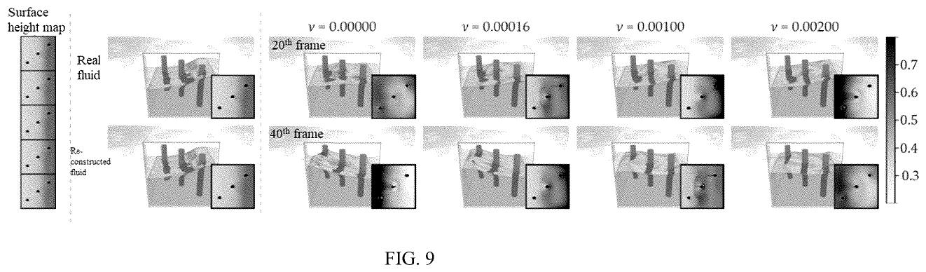

The present disclosure implements fluid three-dimensional reconstruction and re-simulation, and the actual results are shown in FIG. 6. It re-simulates based on the surface height map input from the left (second row), selects 5 frames for display, and compares them with the real scene (first row). In addition, applications such as fluid prediction, surface prediction, and scene re-editing can be expanded and realized. To be specific, the method proposed by the present disclosure supports the re-editing of many fluid scenes in the virtual environment under the physical guidance, such as fluid solid coupling (FIG. 7), multiphase flow (FIG. 8) and viscosity adjustment (FIG. 9). Wherein, FIG. 7 and FIG. 8 show, from left to right, the input surface height map, the reconstructed 3D flow field, and the re-edited results. The first line on the right shows 4 frames of real fluid data, the second line corresponds to the re-edited flow field of the present disclosure. The velocity field data of a selected 2D slice is marked at the bottom right of each result. From the figure it can be seen that the re-editing results based on the present disclosure maintain a high degree of reproducibility. FIG. 9 shows the results of adjusting the fluid to different viscosity values, and selecting the 20^{th} frame and the 40^{th} frame for display, that being marked at the bottom right of each result is the corresponding surface height map. From the figure it can be seen that the smaller the viscosity, the stronger the fluctuations, and on the contrary, the larger the viscosity, the slower the fluctuations, which is consistent with physical cognition.

The above embodiments of the present disclosure have the following beneficial effects: firstly, encoding a fluid surface height field sequence by a surface velocity field convolutional neural network to obtain a surface velocity field at a time t, then inputting the surface velocity field into a pre-trained three-dimensional convolutional neural network to obtain a three-dimensional flow field, meanwhile, inputting the surface velocity field into a pre-trained regression network to obtain fluid parameters, and in the end, inputting the three-dimensional flow field and the fluid parameters into a physics-based fluid simulator to obtain a time series of the three-dimensional flow field, thereby overcoming the problem that the existing fluid capture methods require overly complex equipment and are limited by scenes, providing a data-driven fluid reverse modeling technique from surface motion to spatiotemporal flow field, using a designed deep learning network to learn the flow field's distribution patterns and fluid properties from a large number of datasets, making up for the lack of internal flow field data and fluid properties, and at the same time, conducting time deduction based on physical simulators, and meeting the requirements for real fluid reproduction and physics-based fluid re-editing.

The above description is merely some preferred embodiments of the present disclosure and illustrations of the applied technical principles. Those skilled in the art should understand that the scope of the disclosure involved in the embodiments of the present disclosure is not limited to the technical solutions formed by the specific combination of the above technical features, and should cover at the same time, without departing from the above inventive concept, other technical solutions formed by any combination of the above technical features or their equivalent features, for example, a technical solution formed by replacing the above features with the technical features of similar functions disclosed (but not limited to) in the embodiments of the present disclosure.

1. A three-dimensional fluid reverse modeling method based on physical perception, comprising:
encoding a fluid surface height field sequence by a surface velocity field convolutional neural network to obtain a surface velocity field at a time t;
inputting the surface velocity field into a pre-trained three-dimensional convolutional neural network to obtain a three-dimensional flow field, wherein the three-dimensional flow field includes a velocity field and a pressure field;
inputting the surface velocity field into a pre-trained regression network to obtain fluid parameters; and
inputting the three-dimensional flow field and the fluid parameters into a physics-based fluid simulator to obtain a time series of the three-dimensional flow field.

2. The method of claim 1, wherein the surface velocity field convolutional neural network mentioned above includes a convolutional module group and a dot product mask operation module, the convolutional module group includes eight convolutional modules, and the first seven convolutional modules in the convolutional module group are of a 2DConv-BatchNorm-ReLU structure, while the last convolutional module in the convolutional module group adopts a 2DConv-tanh structure; and
the encoding a fluid surface height field sequence by a surface velocity field convolutional neural network to obtain a surface velocity field at a time t includes:
inputting the fluid surface height field sequence into the surface velocity field convolutional neural network to obtain a surface velocity field at a time t.

3. The method of claim 1, wherein the surface velocity field convolution neural network is a network obtained by using a comprehensive loss function in the training process, wherein the comprehensive loss function is generated by the following steps:
using the pixel level loss function based on L1 norm, spatial continuity loss function based on discriminator, temporal continuity loss function based on discriminator, and loss function based on the constraint physical attributes of the regression network to generate the comprehensive loss function:
L(f_{conv1},Dₛ,Dₜ)=δ×Lₚᵢₓₑₗ+α×L_{D}_{ₛ}+β×L_{D}_{ₜ}+γ×L_{ν},
wherein, L(f_{conv1}, Dₛ, Dₜ) represents the comprehensive loss function, δ represents the weight value of the pixel level loss function based on the L1 norm, Lₚᵢₓₑₗ represents the pixel level loss function based on L1 norm, α represents the weight value of spatial continuity loss function based on discriminator, L_{Ds} represents the spatial continuity loss function based on discriminator, β represents the weight value of temporal continuity loss function based on discriminator, L_{Dt} represents the temporal continuity loss function based on discriminator, γ represents the weight value of the loss function based on the constraint physical attributes of the regression network, L_{ν} represent the loss function based on the constrained physical attributes of the regression network.

4. The method of claim 1, wherein the three-dimensional convolutional neural network includes a three-dimensional deconvolution module group and a dot product mask operation module, the three-dimensional deconvolution module group includes five three-dimensional deconvolution modules, and the three-dimensional deconvolution modules in the three-dimensional deconvolution module group include a Padding layer, a 3DDeConv layer, a Norm layer, and a ReLU layer, the three-dimensional convolutional neural network is a network obtained by using a flow field loss function in the training process; and
the flow field loss function is generated by the following formula:
L(f_{conv2})=ε×E_{u,û}[∥u−û∥₁]+θ×E_{p,\hat{p}}[∥p−\hat{p}∥₁],
wherein, L(f_{conv2}) represents the flow field loss function, ε represents the weight value of the velocity field generated by the three-dimensional convolutional neural network during the training process, u represents the velocity field generated by the three-dimensional convolutional neural network during the training process, û represents the sample true velocity field received by the three-dimensional convolutional neural network during the training process, ∥ ∥₁ represents the L1 norm, θ represents the weight value of the pressure field generated by the three-dimensional convolutional neural network during the training process, p represents the pressure field generated by the three-dimensional convolutional neural network during the training process, \hat{p} represents the sample true pressure field received by the three-dimensional convolutional neural network during the training process, E represents the calculation of mean square error.

5. The method of claim 1, wherein the regression network includes: one 2DConv-LeakyReLU module, two 2DConv-BatchNorm-LeakyReLU modules and one 2DConv module, the regression network being a network obtained by using the mean square error loss function in the training process; and
the above mean square error loss function is generated by the following formula:
L_{ν}=E_{ν,\hat{ν}}[(ν−\hat{ν}))²],
wherein, L_{ν} represents the mean square error loss function, ν represents the fluid parameter generated by the regression network during the training process, \hat{ν} represents the sample true fluid parameter received by the regression network during the training process, E represents the calculation of mean square error.
